(19) United States
(12) Patent Application Publication
(10) Pub. No.: US 2009/0228368 A1
(43) Pub. Date: Sep. 10, 2009

(54) SYSTEMS AND METHODS FOR ENTERPRISE PURCHASING AND PAYMENT

(75) Inventor: Don Reed Brown, Salt Lake, UT (US)

Correspondence Address: AUSTIN RAPP & HARDMAN, 170 South Main Street, Suite 735, SALT LAKE CITY, UT, 84101, US

(73) Assignee: Partnet, Inc., Salt Lake City, UT (US)

(21) Appl. No.: 12/397,107

(22) Filed: Mar. 3, 2009

Related U.S. Application Data
(60) Provisional application No. 61/033,651, filed on Mar. 4, 2008.

(51) Int. Cl. G06Q 30/00; G06Q 20/00; G06Q 40/00

(52) U.S. Cl. 705/26; 705/38

(57) ABSTRACT

A method for enterprise purchasing and payment in an online purchasing and payment system is disclosed. The identity of an enterprise user that is accessing the online purchasing and payment system may be verified. The purchase of an item selected by the enterprise user based on a set of enterprise rules may be authorized. A credit-worthiness determination about the enterprise may be made. Both the authorizing and credit-worthiness determination may be performed in the online purchasing and payment system. An order for a merchant of the selected item may be created based on a description of the selected item.

### RELATED APPLICATIONS

This application is related to and claims priority from U.S. Provisional Patent Application Ser. No. 61/033,651 filed Mar. 4, 2008, for “A Method for Enterprises to Combine the Online Purchasing Processes with the Purchase Card Payment Processes,” with inventor Don R. Brown, which is incorporated herein by reference.

### TECHNICAL FIELD

The present disclosure relates generally to online shopping. More specifically, the present disclosure relates to systems and methods for enterprise purchasing and payment.

### BACKGROUND

Electronic distribution of information has gained in importance with the proliferation of personal computers and has undergone a tremendous upsurge in popularity as the Internet has become widely available. With the widespread use of the Internet, it has become possible to distribute large, coherent units of information using electronic technologies.

Many retailers have set up Internet web sites where consumers can shop for various products that are available for sale, then purchase the desired products and have the products delivered to them for physical items, or downloaded to them for electronic items. The term “online shopping” refers to the process of purchasing products over the Internet. The term “online merchant” may refer to a merchant that has set up an Internet web site through which products may be ordered.

The electronic distribution of information, for example browsing the Internet, online shopping, etc., is popular for a variety of reasons, including its speed and ease of use. In view of the importance of online shopping and the electronic distribution of information, benefits may be realized by improving the systems and methods that facilitate online shopping and the electronic distribution of information.

### BRIEF DESCRIPTION OF THE DRAWINGS

FIG. 1 is a block diagram illustrating one configuration of a system for enterprise purchasing and payment;

FIG. 2 is a flow diagram illustrating an authorizing workflow;

FIG. 3 is a block diagram illustrating a lookup table;

FIG. 4 is a block diagram illustrating another configuration of a system for enterprise purchasing and payment;

FIG. 5 is a block diagram illustrating a system for sending enterprise rules to an online purchasing and payment system;

FIG. 6 is a block diagram illustrating a system for sending item records to an online purchasing and payment system;

FIG. 7 is a flow diagram illustrating a method for approving a purchase by an enterprise customer;

FIG. 8 is a flow diagram illustrating a method for authorizing the purchase of items selected by an enterprise customer; and

FIG. 9 is a block diagram illustrating various components that may be utilized in a computing device.

### DETAILED DESCRIPTION

A method for enterprise purchasing and payment in an online purchasing and payment system is disclosed. The identity of an enterprise user that is accessing the online purchasing and payment system is verified. The purchase of an item selected by the enterprise user is authorized based on a set of enterprise rules. A credit-worthiness determination is made about an enterprise to which the enterprise user belongs. The authorizing and credit-worthiness determination are both performed in the online purchasing and payment system. An order for a merchant of the selected item is created based on a description of the selected item.

The order may be distributed to the merchant, the merchant may be paid for the selected item, and payment may be collected from the enterprise for the selected item. A set of enterprise rules may also be received.

In one configuration, making a credit-worthiness determination may include evaluating whether the enterprise is credit-worthy without interference from a financial institution and extending credit to the enterprise based on the evaluation. Alternatively, making a credit-worthiness determination may include extending credit without evaluating the credit-worthiness of the enterprise. A record of the credit-worthiness determination may be stored in memory in the online purchasing and payment system.

In another configuration, the authorizing may include determining one or more of the following: whether the selected item is less than a predetermined limit, whether the enterprise user is below a predetermined threshold budget, whether the selected item belongs to an approved category, and whether the purchase of the item has been approved by an approver. The enterprise rules may define the predetermined limit, the predetermined budget, the approved categories, and the authorizers.

The authorizing and making may be performed in an authorization module in the online purchasing and payment system. The order may be sent to the merchant using a communication interface, a network interface, or both.

A computer system that is configured to implement an enterprise purchasing and payment system is also disclosed. The computer system includes a processor and memory in electronic communication with the processor. Executable instructions are stored in the memory. The instructions are executable to verify the identity of an enterprise user that is accessing the online purchasing and payment system. The instructions are also executable to authorize the purchase of an item selected by the enterprise user based on a set of enterprise rules. The instructions are also executable to make a credit worthiness determination about the enterprise. The authorizing and credit-worthiness determination are both performed in the online purchasing and payment system. The instructions are also executable to create an order for a merchant of the selected item based on a description of the selected item.

A computer-readable medium that comprises executable instructions is also disclosed. The executable instructions are for verifying the identity of an enterprise user that is accessing the online purchasing and payment system. The executable instructions are also for authorizing the purchase of an item selected by the enterprise user based on a set of enterprise rules. The executable instructions further are for making a credit-worthiness determination about the enterprise. The authorizing and credit-worthiness determination are both performed in the online purchasing and payment system. The executable instructions are also for creating an order for a merchant of the selected item based on a description of the selected item.

Many organizations include multiple members, employees, or agents that are authorized to act on behalf of the organization. For example, a business may purchase needed supplies using credit from a bank. This purchasing may be done by an employee of the business that has been issued a purchasing card linked to a business account. Likewise, many employees of the business may have similar authorization to purchase supplies on behalf of the business. This may be an example of enterprise purchasing. As used herein, the term “enterprise” refers to an organization with more than one employee, at least one of which is authorized to purchase supplies on behalf of the organization. Examples of enterprises may include, without limitation, governments, government agencies, and business entities. Online purchasing in enterprises may include two authorizations: purchasing authorization and payment authorization. Purchasing authorization may include rules established by the enterprise to ensure that the agent of the enterprise is not exceeding their purchasing authority. On the other hand, payment authorization may include rules established to determine the credit-worthiness of the enterprise itself. The rules used in purchasing authorization and payment authorization may overlap.

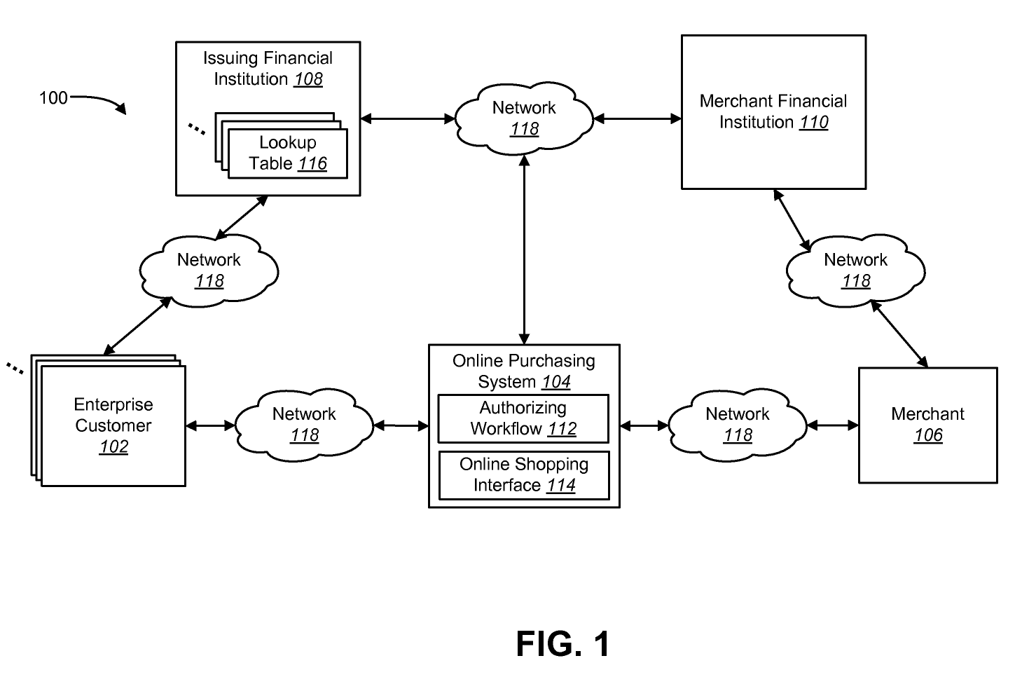

FIG. 1 is a block diagram illustrating one configuration of a system 100 for enterprise purchasing and payment. The system 100 may include one or more enterprise customers 102, an online purchasing system 104, a merchant 106, an issuing financial institution 108, and a merchant financial institution 110. The enterprise customers 102 may be agents of an enterprise, e.g., employees within a government agency. Each enterprise customer 102 may have limited authority to purchase various items on behalf of the enterprise. There may be many enterprise customers 102 in the system 100, each with different purchasing authority. For example, a postal employee may be authorized to purchase office supply items for the postal service, but not food preparation items. Likewise, a mechanic for the Department of Defense may be authorized to purchase automotive parts, but not personal hygiene items on behalf of his employer. In other words, the purchasing authority of the enterprise customers 102 may be limited by rules implemented by the enterprise.

The online purchasing system 104 may include an authorizing workflow 112 that uses the enterprise rules to authorize purchases. The authorizing workflow 112 may include a series of conditions that must be met for the purchase to be authorized. In other words, the authorizing workflow 112 may be responsible for enterprise purchase authorization. The online purchasing system 104 may also include an online shopping interface 114 that may enable the enterprise customer 102 to view items sold by the merchant 106. For example, the online shopping interface 114 may display an item sold by the merchant 106 in a format readable by an internet browser, e.g., HyperText Markup Language (HTML), Extensible Markup Language (XML), Flash by Adobe Systems, Java by Sun Microsystems, etc. This may include displaying various attributes of the item, e.g., item ID, item name, item price, item description, item category, item picture, etc.

In one configuration of the authorizing workflow 112, purchase authorization begins when the enterprise customer 102 identifies him or herself to the online purchasing system 104. This may validate that the enterprise customer 102 is authorized for access. The enterprise customer 102 may then select items to purchase, e.g., by searching from a catalog or by describing the desired items to the online purchasing system 104. The items may be goods or services sold by the merchant 106. The item descriptions may then placed in a list, known as a shopping cart. As the items are selected for the shopping cart, the online purchasing system 104 may apply enterprise rules that regulate which items the particular enterprise customer 102 is allowed to purchase and which combinations of items may be selected. Once the shopping cart is complete, the enterprise customer 102 may then submit it for checkout. The checkout process may involve one or more approvals from one or more human approvers, e.g., the enterprise customer's direct manager or managers of a particular function that relates to the contents of the shopping cart. Purchasing authorization may include additional business rules that check other conditions, such as whether the shopper has exceeded a spending limit for the shopping cart, or exceeded spending limits of a time period, e.g., yearly or monthly spending limits.

The merchant 106 may be a vendor of items. For example, the merchant 106 may sell automotive parts, office supplies, food preparation items, etc. The merchant 106 may wish to sell their items through the online purchasing system 104. In other words, the online purchasing system 104 may act as an online marketplace for one or more merchants 106. The merchant 106 may store item records for all of the items sold by the merchant 106. The item records may include various attributes of the items, e.g., item ID, item name, item price, item description, item category, item picture, etc. These item records may be sent to the online purchasing system 104 and used by the online shopping interface 114 to display the items to the enterprise customers 102.

The online purchasing system 104 may communicate with the enterprise customers 102 and the merchant 106 over a network 118. The networks 118 may represent the Internet, one or more wide area networks (WANs), one or more local area networks (LANs), etc. The networks 118 may be implemented using wired and/or wireless communication technologies and may use any available protocols to pass data between the various illustrated devices and entities.

The issuing financial institution 108 and the merchant financial institution 110 may be responsible for facilitating transactions between the enterprise customers 102 and its suppliers, e.g., the merchant 106. In other words, the financial institutions 108, 110 may perform payment authorization and facilitate payment from the enterprise customers 102 to the merchant 106. When the enterprise customers 102 attempt to purchase an item, the online purchasing system 104 may contact the issuing financial institution 108 for payment authorization. The issuing financial institution 108 may use lookup tables 116 to determine whether to authorize a payment. The lookup tables 116 may include rules that require various conditions relating to the attempted purchase be met. For example, rules may require that the identity of the enterprise customer 102 be verified and that the amount of the item(s) be less than a max limit. Many different rules may be implemented in the lookup table 116. If all the conditions in the lookup table 116 are met, the issuing financial institution 108 may pay the merchant financial institution 110 which may then pay the merchant 106. The issuing financial institution 108 may then collect from the enterprise.

In one configuration, the enterprise customer 102 may identify him or herself to the online purchasing system 104 by presenting a purchase card number. Along with the shopping cart, this information may flow through one or more networks 118 to the issuing financial institution 108 for payment authorization. The issuing financial institution 108 may verify the identity of the enterprise customer 102 and verify whether the shopping cart conforms to pre-set conditions on amount of purchase, types of items purchased, and monthly or yearly limits. These conditions may be in the lookup tables 116, and, if met, an authorization number may be sent back through the network 118 to the online purchasing system 104 to approve the transaction, i.e., payment authorization. The online purchasing system 104 may then convert the shopping cart into a series of orders that are sent to the merchant(s) 106. The merchant(s) 106 may then fill the orders and receive payment from the issuing financial institution 108 via the merchant financial institution 110. The issuing financial institution 108 may then collect from the enterprise, e.g., on a monthly basis.

By using the authorizing workflow 112 to authorize purchases and the lookup tables 116 to authorize payments, the enterprise customer 102 may purchase items from the merchant through the online purchasing system 104.

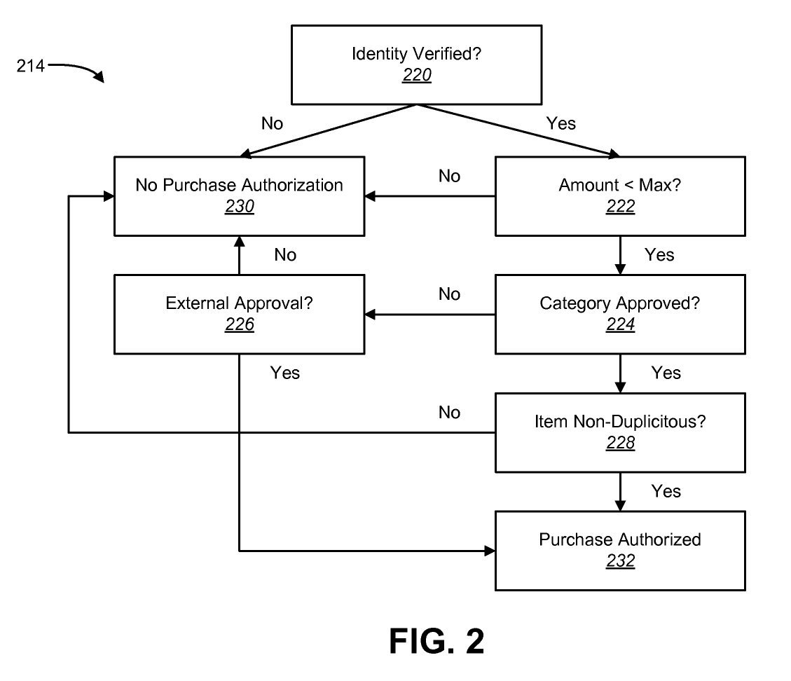

FIG. 2 is a flow diagram illustrating an authorizing workflow 214. The workflow 214 may be implemented in an online purchasing system 104 to authorize purchases. Purchase authorization may begin when the identity of the enterprise customer 102 is verified 220 by identifying him or herself as being authorized for access. If the identity cannot be verified 220, the purchase may not be authorized 230. If the identity is verified 220, the workflow 214 may determine 222 whether the amount of the total purchase is less than a predefined maximum. For example, an enterprise customer 102 may be required to stay within a monthly or yearly budget. Alternatively, an enterprise customer 102 may not be able to purchase item(s) above a dollar amount.

The workflow 214 may also determine 224 whether the category of the desired item(s) is approved. For example, a postal employee may be authorized to purchase office supply items for the postal service, but not food preparation items. Likewise, a mechanic for the Department of Defense may be authorized to purchase automotive parts, but not personal hygiene items. In other words, the purchasing authority of the enterprise customer 102 may be limited to certain categories. If the category is not automatically approved by the workflow 214, the workflow 214 may determine 226 if the enterprise customer 102 has received external approval. For example, the workflow 214 may transmit a message and wait for a response from the supervisor of the enterprise customer 102 or the manager of a particular function that relates to one of the desired items. If the category or categories of item(s) are not approved, either automatically or externally, the purchase may not be authorized 230. If the category or categories of the item(s) are approved, the workflow 214 may determine 228 if the item(s) are non-duplicitous. If the item(s) are non-duplicitous, the purchase may be authorized 232. However, if the item(s) have been purchased before, such as within the last month, the purchase may not be authorized 230.

Note that FIG. 2 illustrates one of many possible configurations. For example, the workflow may not determine 228 whether an enterprise customer 102 purchasing small quantities of office supplies may have previously purchased the same item, such as paper and pens, because of the nature of these items. Similarly, some enterprise customers 102 may be authorized to purchase from all categories. In other words, the workflow 214 may be different in application for every enterprise customer 102.

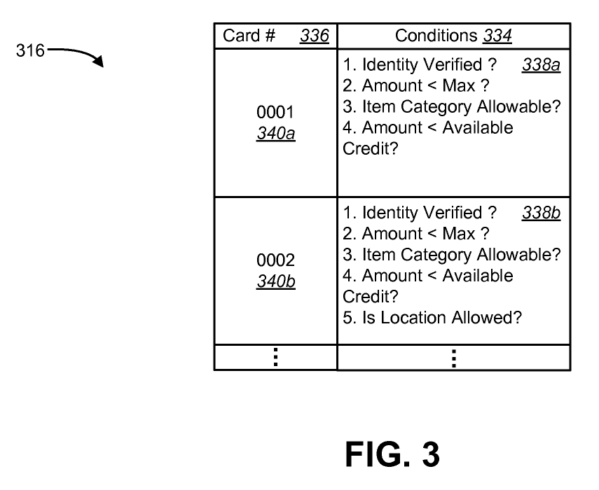

FIG. 3 is a block diagram illustrating a lookup table 316. The lookup table 316 may be implemented in an issuing financial institution 108 for payment authorization. As described above, each member of an enterprise that is authorized to purchase items on behalf of an enterprise may have a purchasing card. The lookup table 116 may include a set of conditions 334 for each card number 336. In other words, the issuing financial institution 108 may determine whether the conditions 334 are met before authorizing a payment on behalf of an enterprise. In one configuration, the conditions 338a for authorizing a payment for a first card 340a may include determining whether the identity of the enterprise customer 102 has been verified, whether the price of the desired purchase is less than a predetermined maximum, whether the category or categories of the item(s) are allowable, and whether the price of the desired purchase is less than the available credit of the enterprise. Likewise, the conditions 338b for authorizing a payment for a second card 340b may be different. For example, the conditions 340b for the second card 340b may include all the conditions 338a for the first card 340a as well as determining whether the attempted purchase is made from an authorized terminal or location, e.g., is the terminal used by the enterprise customer 102 in the correct city.

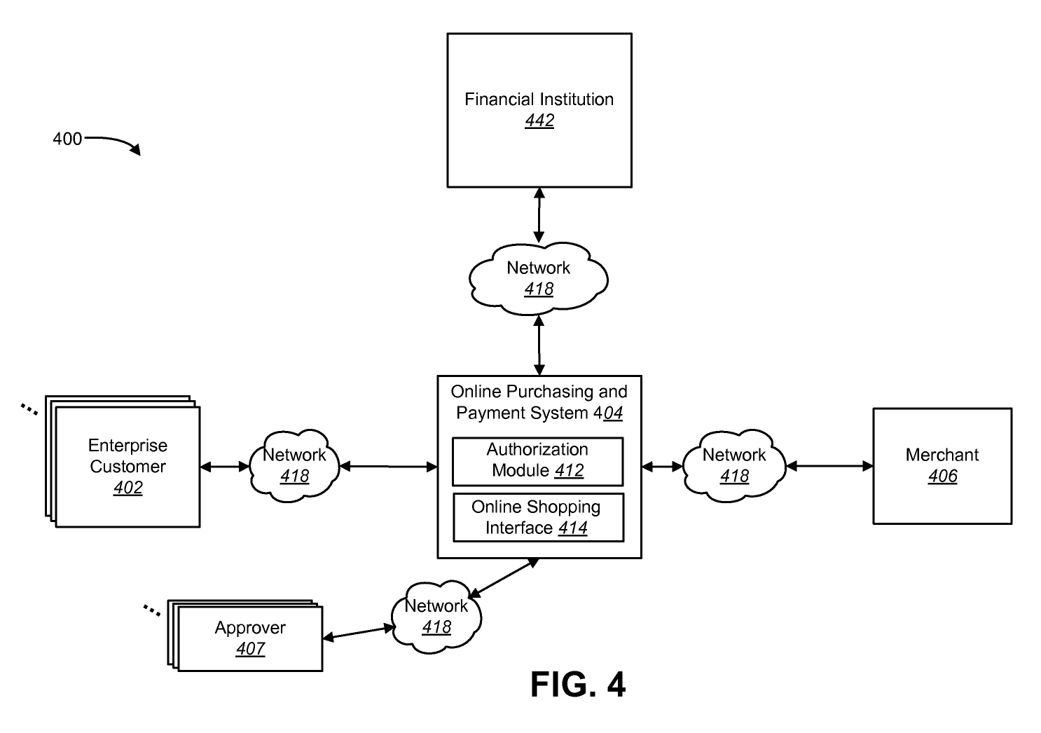

FIG. 4 is a block diagram illustrating another configuration of a system 400 for enterprise purchasing and payment. In this configuration, the system includes one or more enterprise customers 402, an online purchasing and payment system 404, one or more merchants 406, and optionally a financial institution 442. This configuration may improve the online purchasing and payment processes by consolidating the purchasing authorization and the payment authorization into an online purchasing and payment system 404. This may eliminate many of the steps duplicated in the authorizing workflow 112 and the lookup table 116 and improve the efficiency of the system 400 as a whole. Additionally, this system 400 may be implemented without any change to the enterprise customer(s) 402 or the merchant(s) 406.

As before the enterprise customer 402 may be an agent of an enterprise and have limited authority to purchase various items on behalf of the enterprise. The enterprise customer 402 may communicate with the online shopping interface 414 using a network 418. The online shopping interface 414 may display the attributes of items sold by one or more merchants 406, e.g., item ID, item name, item price, item description, item category, etc. In one configuration, the online shopping interface 414 displays a web page with the attributes of item(s) sold by the merchant(s) 406. If the enterprise customer 402 wishes to purchase item(s), he or she may be required to verify their identity to the online purchasing and payment system 404. This may include entering a username and password and/or answering one or more questions. Alternatively, the enterprise customer 402 may be required to verify their identity before they are allowed to access the online shopping interface 414 to view the items.

Once an enterprise customer 402 has placed their desired purchases in a shopping cart and proceeded to checkout, the item(s) in the shopping cart may be checked by the authorization module 412 for conformity to the enterprise's rules. As before, these rules may include total purchase dollar limits, yearly or monthly dollar limits, category limits, non-duplicity limits, etc. Once completed, the shopping cart may be routed to the requisite approvers 407, e.g., one or more supervisors that approve the item(s). Then, the items in the shopping cart may be distributed as orders to the merchant(s) 406 who may fill the orders and ship the item(s) to the enterprise customer 402. The online purchasing and payment system 404 may then pay the merchant(s) 406 and collect from the enterprise, e.g., on a periodic basis.

One advantage of the configuration illustrated in FIG. 4 may be that many of the checks associated with the authorizing workflow 112 and the lookup table 116 need not be done more than once, e.g., verifying identity, category limits, purchasing limits, etc. Additionally, the cost involved with the issuing financial institution 108 and the merchant financial institution 110 may be eliminated. Therefore, in one configuration, the authorization module 412 in the online purchasing and payment system 404 may perform purchasing authorization and payment authorization. In another configuration, the authorization module 412 may perform purchasing authorization, and no payment authorization is performed. In other words, there may be no need for a bank to determine the credit-worthiness of an enterprise customer 402. For example, the enterprise customer 402 may be deemed credit worthy at all times, e.g., a government agency. In these configurations, the overall cost of the transaction may be minimized because the financial institutions may not be involved.

The financial institution 442 may optionally be involved in transactions at the discretion of the online purchasing and payment system 404. For example, if the enterprise customer 402 desires to purchase very expensive item(s), the online purchasing and payment system 404 may not be able to extend enough credit to the enterprise. In this situation, the online purchasing and payment system 404 may work with the financial institution 442 to extend the credit for the item(s).

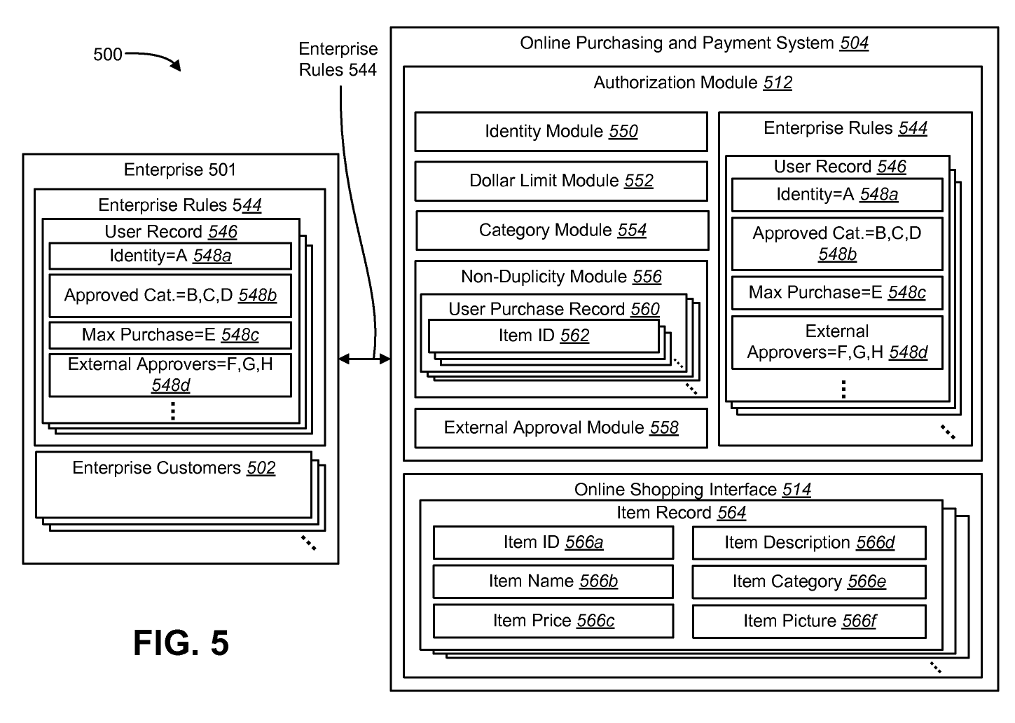

FIG. 5 is a block diagram illustrating a system 500 for sending enterprise rules 544 to an online purchasing and payment system 504. In the system 500, the enterprise 501 may be any organization that purchases items and may include enterprise rules 544 and enterprise customers 502. The enterprise customers 502 may be agents of the enterprise 501, e.g., an employee within a government agency. In one configuration, the enterprise rules 544 may be created, modified, maintained, and sent to the online purchasing and payment system 504 by the entity or person within the enterprise 501 that is responsible for monitoring purchasing by the enterprise 501, e.g., a purchasing department. The enterprise rules 544 may indicate permissions for people or groups, i.e., enterprise customers 502. For example, the enterprise rules 544 may include a user record 546 for each person within the enterprise 501 that has some level of purchasing permission. Each user record 546 may include a series of rules 548 that may be used when authorizing an attempted purchase by the enterprise customers 502. These rules 548 may include the identity of the user 548a, the approved categories of items 548b, the max purchase amount 548c, the approvers 548d, etc. The enterprise 501 may send the enterprise rules 544 to the online purchasing and payment system 504, where they may be used in the authorization module 512.

The authorization module 512 may be responsible for purchase authorization and, when appropriate, payment authorization. There may be a module responsible for checking each rule 548 for purchase authorization. In other words, when an enterprise customer 502 attempts to purchase item(s) through the online shopping interface 514, the authorization module 512 may determine whether to authorize the purchase based on the rules 548. An identity module 550 may verify the identity of the purchaser using the identity rule 548a, e.g., determine whether the purchaser has permission to use the online purchasing and payment system 504. A dollar limit module 552 may verify that the attempted purchase is less than some predefined dollar limit using the max purchase rule 548c, e.g., whether the price of a single item or the entire shopping cart exceeds a predefined value. A category module 554 may verify that all the items in the shopping cart are from approved categories using the approved categories rule 548b. A non-duplicity module 556 may verify that the attempted purchase has not been made recently based on user purchase records 560 that may include, among other attributes, the item ID 562 for every purchase made by the user. This module 556 may include exceptions for certain items. For example, if an enterprise customer 502 purchased office supplies recently, this may not disqualify more office supplies from receiving purchase authorization because office supplies may be consumed and may need replenishing. On the other hand, if an enterprise customer 502 recently purchased an automotive item within the past week, this may prevent purchase authorization for the identical item because it is likely duplicitous. Or, if recently purchased, an item may require special approval from a human approver 407 before it is given purchase authorization. Additionally, the non-duplicity module 556 may verify the current shopping cart against the user purchase records 560 of other people, e.g., people within the same department or agency. Furthermore, an external approval module 558 may request approval from one or more approvers 407 using the approvers rule 548d. For example, some enterprise customers 502 may require human approval for all purchases. Similarly, some items may require human approval, regardless of the enterprise customer 502. This human approval may use any communication means, e.g., instant message, short message service (SMS), e-mail, etc.

The online purchasing and payment system 504 may also include an item record 564 for items sold by one or more vendors. Each item record 564 may include item attributes that may be displayed to the enterprise customer 502, e.g., item ID 566a, item name 566b, item price 566c, item description 566d, item category 566e, item picture 566f, etc.

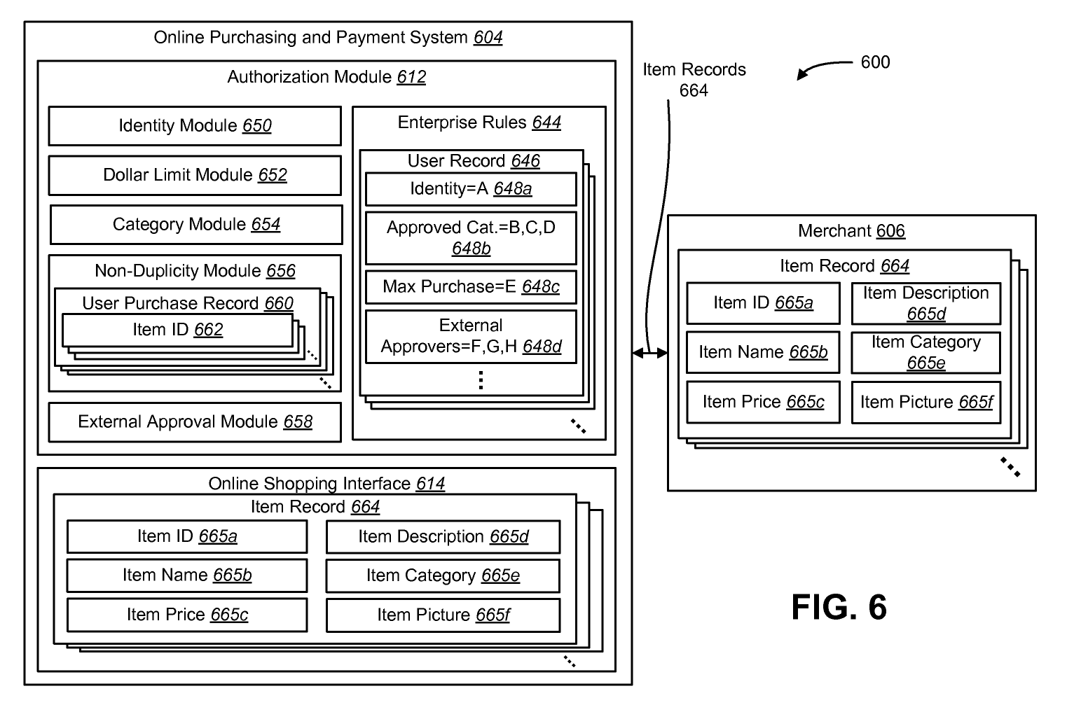

FIG. 6 is a block diagram illustrating a system 600 for sending item records 664 to an online purchasing and payment system 604. The merchant 606 may be a vendor of items and may wish to sell their items through the online purchasing and payment system 604. In other words, the online purchasing and payment system 604 may act as an online marketplace for one or more merchants 606 by displaying item attributes 665 using the online shopping interface 614. The merchant 606 may store item records 664 for all of the items sold by the merchant 606. The item records 664 may include various attributes of the items, e.g., item ID 665a, item name 665b, item price 665c, item description 665d, item category 665e, item picture 665f, etc. These item records 664 may be sent to the online purchasing and payment system 604 and used by the online shopping interface 614 to display the items to an enterprise customer 402.

The online purchasing and payment system 604 may also include an authorization module 612 that performs purchase authorization and, if necessary, payment authorization. The authorization module 612 may include a module that checks each rule 648 for purchase authorization. In other words, an identity module 650 may verify the identity of the enterprise customer 402 based on the identity rule 648a. Likewise, the dollar limit module 652 may determine whether the attempted purchase is within a dollar limit based on the max purchase rule 648c. Likewise, the category module 654 may determine whether the item(s) in the shopping cart are in approved categories based on the approved categories rule 648b. Likewise, the non-duplicity module 656 may determine whether the item(s) in the shopping cart are non-duplicitous based on past user purchase records 660 that include an item ID 662 for each item previously purchased by a particular user. Likewise, an external approval module 658 may request approval from one or more approvers 407 using the approved approvers rule 648d.

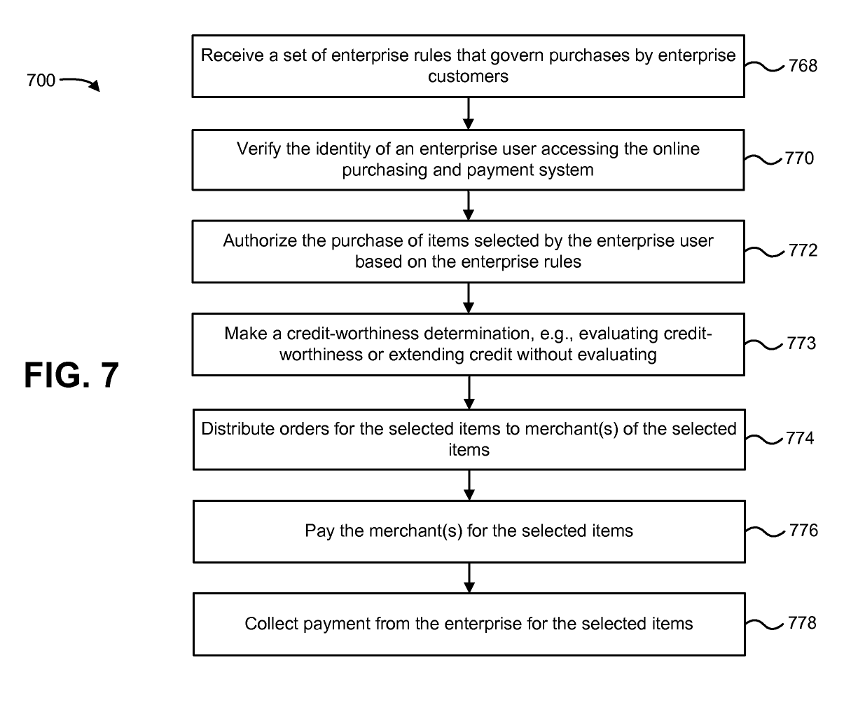

FIG. 7 is a flow diagram illustrating a method 700 for authorizing a purchase by an enterprise customer 402. This may include purchase authorization and/or payment authorization and may be performed by an online purchasing and payment system 404. The system 404 may receive 768 a set of enterprise rules 544 that govern purchases by enterprise customers 402. The system 404 may verify 770 the identity of an enterprise customer 402 accessing the system 404. The system 404 may authorize 772 the purchase of items selected by the enterprise customer 402 based on the enterprise rules 544, i.e., purchase authorization. The system 404 may also make 773 a credit-worthiness determination about the enterprise. For example, a credit-worthiness determination may include evaluating the credit-worthiness of the enterprise 501 and then extending credit for the item(s) based on that evaluation. Alternatively, the credit-worthiness determination may include extending credit to the enterprise 501 without evaluating their credit-worthiness. Therefore, in one configuration, there are no financial institutions 442 involved in the transaction, and the online purchasing and payment system 404 performs both purchase authorization using the enterprise rules 544 and payment authorization. In another configuration, payment authorization is not performed on the items in the shopping cart. A record of the credit-worthiness determination may be stored in memory (not shown) in the system 404, e.g., data indicating whether the credit-worthiness of the enterprise 501 was evaluated and whether credit was extended to the enterprise 501. Note that one way of performing payment authorization has traditionally been for the system 404 to communicate with an issuing financial institution 108 to determine the credit-worthiness of the enterprise customer 402. However, in some configurations, the present systems and methods eliminate the payment authorization all together because the enterprise customer 402 may always be considered credit-worthy, e.g., government agencies.

The system 404 may also distribute 774 orders for the selected items to merchant(s) 406 of the selected items and pay 776 the merchant(s) 406 for the selected items. The system 404 may then collect 778 payment from the enterprise 501 for the selected items, e.g., with monthly statements. Based on the order distributed to the merchant(s) 406, goods or services may then be shipped from the merchant(s) 406 to the enterprise customer 402.

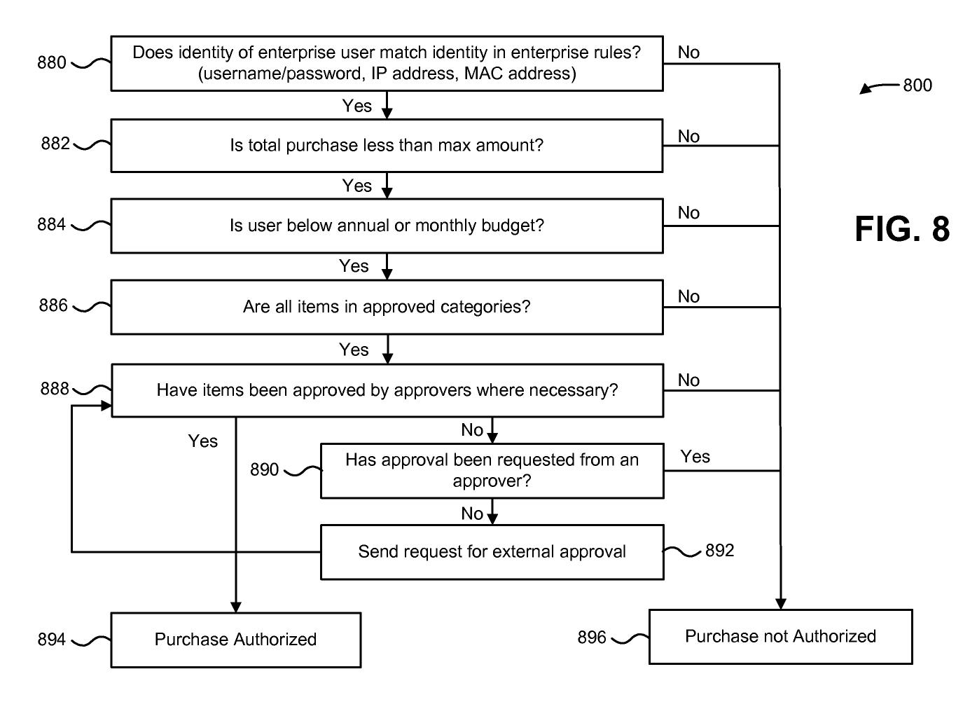

FIG. 8 is a flow diagram illustrating a method 800 for authorizing the purchase of items selected by an enterprise customer 402. In other words, the method 800 may be used alternatively, or in addition to, step 772 in the method 700 of FIG. 7. The method 700 may include a series of conditions that, if not met, will not result in purchase authorization 896. In contrast, if all the conditions are met, the purchase may be authorized 894.

First, the system 404 may determine 880 if the identity of the enterprise customer 402 matches an identity in the enterprise rules 544. The identity of the enterprise customer 402 may be ascertained using a username and password, or the IP address or MAC address of the enterprise customer 402. The system 404 may also determine 882 if the total purchase is less than the max purchase. The max purchase may indicate a maximum for a shopping cart, for a single item, etc. The system 404 may also determine 884 if the enterprise customer 402 is below their annual or monthly budget. The system 404 may also determine 886 whether all the items in the shopping cart belong to approved categories. For example, a postal employee may be authorized to purchase office supply items for the postal service, but not food preparation items. Likewise, a mechanic for the Department of Defense may be authorized to purchase automotive parts, but not person hygiene items. The system 404 may also determine 888 whether all the items in the shopping cart have been approved by an approver. In one configuration, only items in particular categories, or in a particular price range require human approval. If approval has been received, the purchase may be authorized 894. If approval has not been received, the system may determine 890 if approval has been requested. If yes, and the approval was not received, the shopping cart may not receive purchase authorization 896. If no authorization has been requested, the system 404 may send 892 a request for approval to an authorizer, e.g., the user's direct manager or a manager of a particular function that relates to the contents of the shopping cart.

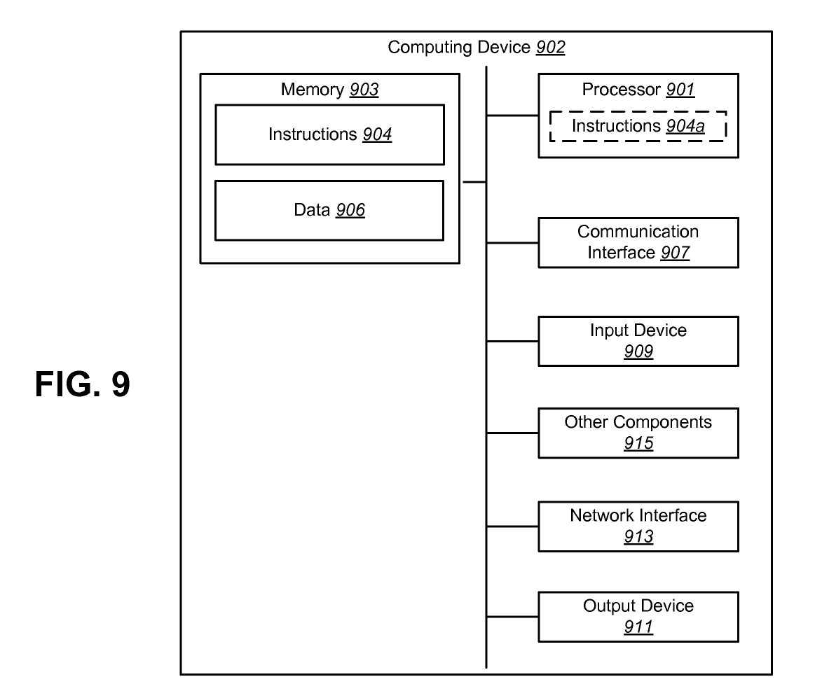

FIG. 9 is a block diagram illustrating various components that may be utilized in a computing device 902. The computing device 902 may implement an online purchasing and payment system 404, 504, 604. Although only one computing device 902 is shown, the configurations herein may be implemented in a distributed system using many computer systems. Computing devices 902 may include the broad range of digital computers including microcontrollers, hand-held computers, personal computers, servers, mainframes, supercomputers, minicomputers, workstations, and any variation or related device thereof.

The computing device 902 is shown with a processor 901 and memory 903. The processor 901 may control the operation of the computing device 902 and may be embodied as a microprocessor, a microcontroller, a digital signal processor (DSP) or other device known in the art. The processor 901 typically performs logical and arithmetic operations based on program instructions stored within the memory 903. The instructions 904 in the memory 903 may be executable to implement the methods described herein.

The computing device 902 may also include one or more communication interfaces 907 and/or network interfaces 913 for communicating with other electronic devices. The communication interface(s) 907 and the network interface(s) 913 may be based on wired communication technology, and/or wireless communication technology.

The computing device 902 may also include one or more input devices 909 and one or more output devices 911. The input devices 909 and output devices 911 may facilitate user input/user output. Other components 915 may also be provided as part of the computing device 902.

Data 906 and instructions 904 may be stored in the memory 903. The processor 901 may load and execute instructions 904a from the instructions 904 in memory 903 to implement various functions. Executing the instructions 904 may involve the use of the data 906 that is stored in the memory 903. The instructions 904 are executable to implement one or more of the processes or configurations shown herein, and the data 906 may include one or more of the various pieces of data described herein.

The memory 903 may be any electronic component capable of storing electronic information. The memory 903 may be embodied as random access memory (RAM), read only memory (ROM), magnetic disk storage media, optical storage media, flash memory devices in RAM, on-board memory included with the processor, EPROM memory, EEPROM memory, an ASIC (Application Specific Integrated Circuit), registers, and so forth, including combinations thereof.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Functions such as executing, processing, performing, running, determining, notifying, sending, receiving, storing, requesting, and/or other functions may include performing the function using a web service. Web services may include software systems designed to support interoperable machine-to-machine interaction over a computer network, such as the Internet. Web services may include various protocols and standards that may be used to exchange data between applications or systems. For example, the web services may include messaging specifications, security specifications, reliable messaging specifications, transaction specifications, metadata specifications, XML specifications, management specifications, and/or business process specifications. Commonly used specifications like SOAP, WSDL, XML, and/or other specifications may be used.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for enterprise purchasing and payment in an online purchasing: and payment system, comprising:
verifying the identity of an enterprise user that is accessing the online purchasing and payment system;
authorizing the purchase of an item selected by the enterprise user based on a set of enterprise rules;
making a credit-worthiness determination about an enterprise to which the enterprise user belongs, wherein the authorizing and credit-worthiness determination are both performed in the online purchasing and payment system; and
creating an order for a merchant of the selected item based on a description of the selected item.

2. The method of claim 1, further comprising:
distributing the order to the merchant;
paying the merchant for the selected item; and
collecting payment from the enterprise for the selected item.

3. The method of claim 1, further comprising receiving the set of enterprise rules.

4. The method of claim 1, wherein the making comprises:
evaluating whether the enterprise is credit-worthy without interference from a financial institution; and
extending credit to the enterprise based on the evaluating.

5. The method of claim 1, wherein the making comprises extending credit without evaluating the credit-worthiness of the enterprise.

6. The method of claim 1, wherein the authorizing comprises determining one or more of the following: whether the selected item is less than a predetermined limit, whether the enterprise user is below a predetermined budget, whether the selected item belongs to an approved category, whether the purchase of the item has been approved by an approver.

7. The method of claim 6, wherein the enterprise rules define the predetermined limit, the predetermined budget, the approved categories, and the approvers.

8. The method of claim 1, wherein the authorizing and making are performed in an authorization module in the online purchasing and payment system.

9. The method of claim 1, further comprising sending the order to the merchant using at least one of a communication interface and a network interface.

10. The method of claim 1, further comprising storing a record of the credit-worthiness determination in memory in the online purchasing and payment system.

11. A computer system that is configured to implement an enterprise purchasing and payment system, the computer system comprising:
a processor;
memory in electronic communication with the processor;
instructions stored in the memory, the instructions being executable to:
verify the identity of an enterprise user that is accessing the online purchasing and payment system;
authorize the purchase of an item selected by the enterprise user based on a set of enterprise rules;
make a credit-worthiness determination about the enterprise, wherein the authorizing and credit-worthiness determination are both performed in the online purchasing and payment system; and
create an order for a merchant of the selected item based on a description of the selected item.

12. The computer system of claim 11, further comprising instructions being executable to:
distribute the order to the merchant;
pay the merchant for the selected item; and
collect payment from the enterprise for the selected item.

13. The computer system of claim 11, further comprising instructions executable to receive the set of enterprise rules.

14. The computer system of claim 11, wherein the instructions executable to make comprise instructions executable to:
evaluate whether the enterprise is credit-worthy without interference from a financial institution; and
extend credit to the enterprise based on the evaluating.

15. The computer system of claim 11, wherein the instructions executable to make comprise instructions executable to extend credit without evaluating the credit-worthiness of the enterprise.

16. The computer system of claim 11, wherein the instructions executable to authorize comprise instructions executable to determine one or more of the following: whether the selected item is less than a predetermined limit, whether the enterprise user is below a predetermined budget, whether the selected item belongs to an approved category, whether the purchase of the item has been approved by an approver.

17. The computer system of claim 11, wherein the enterprise rules define the predetermined limit, the predetermined budget, the approved categories, and the approvers.

18. The computer system of claim 11, further comprising an authorization module configured to authorize the purchase and make the credit-worthiness determination.

19. The computer system of claim 11, further comprising at least one of a communication interface and a network interface configured to send the order to the merchant.

20. The computer system of claim 11, further comprising instructions executable to store a record of the credit-worthiness determination in the memory.

21. A computer-readable medium comprising executable instructions for:
verifying the identity of an enterprise user that is accessing the online purchasing and payment system;
authorizing the purchase of an item selected by the enterprise user based on a set of enterprise rules;
making a credit-worthiness determination about the enterprise, wherein the authorizing and credit-worthiness determination are both performed in the online purchasing and payment system; and
creating an order for a merchant of the selected item based on a description of the selected item.

22. The computer-readable medium of claim 21, further comprising executable instructions for:
distributing the order to the merchant;
paying the merchant for the selected item; and
collecting payment from the enterprise for the selected item.

23. The computer-readable medium of claim 21, wherein the making comprises instructions for:
evaluating whether the enterprise is credit-worthy without interference from a financial institution; and
extending credit to the enterprise based on the evaluating.

24. The computer-readable medium of claim 21, wherein the making comprises instructions for extending credit without evaluating the credit-worthiness of the enterprise.
